(19) United States
(12) Patent Application Publication
(10) Pub. No.: US 2005/0103627 A1
(43) Pub. Date: May 19, 2005

(54) Methods of selective capillary electrophoresis

(75) Inventors: Matthias Pelzing, Leipzig (DE); Christian Neususs, Leipzig (DE)

Correspondence Address: KUDIRKA & JOBSE, LLP, ONE STATE STREET, SUITE 800, BOSTON, MA, 02109, US

(73) Assignee: Bruker Daltonik GMBH, Bremen (DE)

(21) Appl. No.: 10/932,884

(22) Filed: Sep. 2, 2004

(30) Foreign Application Priority Data
Sep. 3, 2003 (DE) 103 40 521.6

(51) Int. Cl. G01N 27/453

(52) U.S. Cl. 204/451; 204/549

(57) ABSTRACT

The invention relates to methods for investigating mixtures of substances by capillary electrophoretic separation, in particular of biopolymers such as proteins, proteoglycanes or other protein conjugates, or their digestion peptides. The invention comprises the analysis of specific, well-separated substances of analytical interest found in complex mixtures by subjecting the mixture of substances together to a selective derivatization process using charge-carrying groups prior to the electrophoretic separation, so that the substances of interest can be detected, essentially alone, within a specified time window.

### FIELD OF THE INVENTION

The invention relates to methods for investigating mixtures of substances by capillary electrophoretic separation, in particular of biopolymers such as proteins, proteoglycanes or other protein conjugates, or their digestion peptides.

### BACKGROUND OF THE INVENTION

In the analysis of biochemical polymers, in particular in the differential expression analysis of isotope-marked proteins from two differently stressed proteomes, fast, high-resolution separation procedures are wanted in order to provide alternatives to the slow, poorly reproducible 2-D gel electrophoresis technique, which is restricted in terms of hydrophobicity and basicity. Prominence is given here to methods in which initial mixtures of isotope-marked proteins or of their conjugates are digested before the application of separation methods, yielding digestion mixtures containing tens of thousands or hundreds of thousands of digestion peptides; it is then desired to separate these from one another and to subject them, for instance, to mass spectrometric analysis. It is often, however, not important to analyze all the digestion peptides of a protein—in the limiting case, one digestion peptide per protein is sufficient to find proteins that are over or under expressed. Procedures are therefore wanted which not only offer high performance in separating the mixtures, but which also permit the selection of particular substances out of the mixture, for instance the selection of a single digestion peptide per protein. Such procedures, which simultaneously select and separate, are also wanted in other fields of biochemical analysis, not just in differential expression analysis.

Peptides can be separated by capillary electrophoresis, and can be detected either by direct coupling with electrospray ionization (ESI) or, following preparation on sample carriers, by ionization using matrix assisted laser desorption (MALDI) and mass spectrometry. If, in the course of analysis in a tandem mass spectrometer (MS-MS), an interesting molecular ion is separated (“isolated”) from the others and further fragmented, then a partial structure of the sequence of amino acids can be derived by determining the mass of the daughter ions. This can be used to identify unknown peptides and proteins with the aid of protein sequence databases. The sequences of many peptides and proteins are known.

Having once identified the peptides, it is often sufficient to accurately determine the mass in association with the migration time in the electrophoretic capillary column in order to recognize the peptide in a specific mixture type. This technique, however, reaches its limits as soon as a highly complex mixture of proteins (up to those of a complete cell lysate) is involved, since the separating capacity of capillary electrophoresis (CE), like that of liquid chromatography (HPLC), is no longer sufficient to substantially separate the various digestion peptides found in such a mixture. This also applies to the increasingly used two-dimensional separation techniques (e.g. CE-HPLC). Incompletely separated mixtures mean that due to the concurrent ionization in the electron spray there are no longer sufficient peptides available to allow all the proteins in the mixture to be separated. Due to the concurrent ionization, quantification of the proteins is also not possible when separation is incomplete.

Unambiguous identification and quantification therefore necessitate a reduction in the number of peptides to be analyzed without losing any information about all the proteins in the initial mixture in the process. Several methods have been suggested for this purpose. This includes, most particularly, a process known as “ICAT” (isotope coded affinity tag), in which the cysteines are derivatized with a reactant, where the reactant possesses a chemical group for specific enrichment by affinity extraction in addition to an isotopic marker. By using different isotopes in different investigation groups, it is thus possible to determine the different expression of proteins by mass spectrometry.

A further possibility is to restrict the analysis to peptides with other rare amino acids which are representative of the protein concerned within an organism's proteome; thus, for the human proteome, the proportion of cysteine is estimated to be 2.3%, of tryptophan 1.2%, histidine 2.6%, tyrosine 2.7%, and methionine 2.1%. For example, it is possible to exploit the fact that only the peptides that contain methionine alter their retention time in a further pass following oxidation of an LC fraction and can thus be used to characterize the methionine-containing proteins of the whole protein under analysis. Terminal digestion peptides can also be filtered out by this procedure. So-called “diagonal chromatography” makes use of a series of cyclically collected fractions from which, by intermediate derivatization, the interesting peptides migrate during a second chromatography in the same column into the unoccupied intermediate regions, and so can be separately analyzed (WO 02/077 016 A2, Vanderkerckhove and Gevaert).

In addition to identifying and quantifying proteins, determining the type and proportion of post-translational modifications (PTM) of a protein is increasingly playing a role. These are of crucial importance for the function of proteins. Various selective enrichment techniques (affinity enrichment) and MS-MS measurement techniques have been suggested for this purpose, but they are not universally applicable.

Capillary electrophoresis (CE) has been found to be a separation procedure of unmatched separation efficiency. Capillary electrophoresis can, as suggested above, be coupled with mass spectrometry (CE/MS), using either ionization by electron spray (ESI), or matrix assisted laser desorption (MALDI).

There are various types of capillary electrophoresis, such as capillary zone electrophoresis (CZE), capillary gel electrophoresis (CGE), capillary iso-electric focusing (CIEF), capillary isotachophoresis (ITP) and others, of which capillary zone electrophoresis is of particular interest here. A good overview of the application of capillary zone electrophoresis to protein analysis can be obtained from the general article by V. Kasicka (Electrophoresis 2001, 22, 3084-3105). Of the various charging methods for the capillaries, we will here only mention that there are methods with and without substance focusing, in addition to online solid phase extraction (SPE).

For coupling with mass spectrometry, focusing methods are preferred, since coupling with mass spectrometry can demonstrate a relatively high separation efficiency. Coupling with mass spectrometry in order to characterize peptides and proteins is described in the general article by Figeys and Aebersold (Electrophoresis 1998, 19, 855-892).

The fundamental principle of electrophoresis is that when the substances of a dissolved mixture of molecules capable of electrolytic dissociation are inserted together, within a small volume, into the capillary, they migrate through the capillary column under the influence of a relatively strong electric field in the electrolytic liquid with which the capillary is filled. The migration speeds of the individual components of the mixture are different. These substances separate, as they do in chromatography. The reason for this separation is the pH-depending charge of the substance molecules, and their different size.

Capillary electrophoresis, in particular capillary zone electrophoresis, has the great advantage over other separating methods, such as liquid chromatography, that extremely good separation can be achieved in a short separating time. Thus separations with more than a million theoretical plates can be achieved in less than 20 minutes; plate counts of more than 100,000 in less than one minute. Capillary electrophoresis, in particular capillary zone electrophoresis, has the great advantage over other separating methods, such as liquid chromatography, that extremely good separation can be achieved in a short separating time. Thus separations with more than a million theoretical plates can be achieved in less than 20 minutes; plate counts of more than 100,000 in less than one minute.

Three partial electric currents flow in the electrophoretic capillary: (1) the electrolytic current due to the migrating substance ions, whose charge, averaged over time, depends on the pH value of the solution, (2) an electroosmotic current due to the effect of stationary wall charges on the solution, generating an electroosmotic propulsion of the liquid, and (3) a generally large electrolytic current through the acids, bases or salts in the solution that determine the pH value (separation buffers). All types of capillary electrophoresis have the advantage that the heat generated by these currents is very effectively conducted away by the capillary walls, making relatively high current densities possible.

The electroosmotic effect arises because the stationary wall charges created by the electrolytes induce mobile charges in the liquid, and under the influence of the potential difference these give rise to an electric current, and also to an electroosmotic flow (EOF). The electroosmotic flow pumps small quantities of liquid through the capillary. The direction and magnitude of this liquid flow depend on the type of wall charges, the diameter of the capillary, the field strength, and the polarity of the electric field. The electroosmotic effect arises because the stationary wall charges created by the electrolytes induce mobile charges in the liquid, and under the influence of the potential difference these give rise to an electric current, and also to an electroosmotic flow (EOF). The electroosmotic flow pumps small quantities of liquid through the capillary. The direction and magnitude of this liquid flow depend on the type of wall charges, the diameter of the capillary, the field strength, and the polarity of the electric field.

The wall charges can be influenced by coating the capillary wall with polymers. For instance, negative wall charges are generated in an uncoated silica glass capillary. By bonding specific organic compounds to the wall, for example by aminopropylsilylation, positive wall charges can, in contrast, be created.

The electroosmotic flow has quite different properties from a flow arising in the capillary under the influence of external pressure. Under external pressure, a parabolic velocity profile develops, with a maximum velocity close to the capillary axis and a velocity of zero at the capillary wall. In the case of an electroosmotic flow, the distribution is different: here the column of liquid moves as a whole, undistorted, through the capillary, and the flow velocities are the same at all points across the cross section. The reason for this is that the propulsion is similar to that of a linear motor at the capillary wall surface, and this has an effect on the induced charges in the column of liquid. The molecules in a “front” of the liquid column therefore remain in that front, and can only move out of that front through a very slow process of axial diffusion. The electroosmotic flow has quite different properties from a flow arising in the capillary under the influence of external pressure. Under external pressure, a parabolic velocity profile develops, with a maximum velocity close to the capillary axis and a velocity of zero at the capillary wall. In the case of an electroosmotic flow, the distribution is different: here the column of liquid moves as a whole, undistorted, through the capillary, and the flow velocities are the same at all points across the cross section. The reason for this is that the propulsion is similar to that of a linear motor at the capillary wall surface, and this has an effect on the induced charges in the column of liquid. The molecules in a “front” of the liquid column therefore remain in that front, and can only move out of that front through a very slow process of axial diffusion.

The externally applied voltage now creates a homogenous electric field in the liquid column, and the molecules of the substance migrate in this field. The velocity of the migration in the liquid is determined only by their charge (force) and the friction that opposes them; the charge is determined by the degree of dissociation at the prevailing pH value, and the friction is determined by their shape and size. The process is similar to that of ion mobility spectrometry, in which ions are drawn through a gas by an electric field. The friction is approximately proportional to the cross section, as determined by the molecular weight, but also depends on other shape factors and on the agglomeration of other molecules, such as those of the solvent. The velocity rises in linear proportion to the strength of the electric field. Due to the extremely high dilution of the molecules being analyzed in the electrolyte, migration of these molecules only has a weak influence on the electroosmotic flow. The separation capacity of a capillary or other channel of a given cross section depends, to a first approximation, only on the length (the “number of theoretical plates per length unit” is referred to). To a first approximation, the separation capability is not dependent on the applied voltage; the voltage does, however, determine the speed of separation for a given length and therefore the time required for an electrophoretic separation pass. For the purposes of most applications it is precisely this high separation speed that makes capillary electrophoresis attractive.

On closer examination we see that the separation speed must not be lowered too far, since the axial diffusion of the substances that overlays the migration then reduces the separation efficiency; this effect is, however, very weak, and the separation efficiency is, in practice, the same over wide ranges of applied voltage. This contrasts sharply with chromatography, in which it is only through the interplay of axial and radial diffusion that optimum separation performance is reached. Optimum separation efficiency is only achieved at an optimum flow rate; this optimum is named the van Deemter optimum after its discoverer.

The electroosmotic flow under highly acid conditions in silica glass capillaries is very small; the flow velocity thus scarcely comes up to the migration rate of the slowest positively charged substance molecules.

Electrophoresis is increasingly used in the study of proteomes, namely for the separation of the digestion peptides of proteins. The dissociation of the digestion peptides yields charged peptide ions which, in dissociation equilibrium in an acid medium, possess between about one and three positive charges. For instance, in an electrophoresis capillary of silica glass with an internal diameter of about 50 micrometers and a length of 50 centimeters to which 30 kilovolts is applied, the first peptides in an acid separation buffer reach the end of the capillary after about six minutes, at which stage they can be detected. The slowest peptides require about 10 minutes. In another five minutes, the neutral substances, which are transported by the electroosmotic flow alone, reach the detector end. These neutral substances do not, under these conditions, belong to the peptides, and are of no interest to the analysis. Very weakly negatively charged ions, whose electrophoretic migration rate is, absolutely speaking, smaller than the velocity of the electroosmotic flow, then arrive later than the electroosmotic flow at the detector; more strongly negatively charged ions can, on the other hand, never reach the detector, because they migrate to the inlet end.

FIG. 1 illustrates a typical electrophorogram of a protein digestion peptide mixture in which polluting neutral substances appear with the electroosmotic flow.

Ionization by electro spray, which can be directly coupled with electrophoretic capillary separation, generates a continuous beam of ions. Either the classic sector field spectrometer or the quadrupole spectrometer may now be applied for analysis. Both types may be used in a tandem arrangement in order to carry out MS/MS investigations. Time-of-flight mass spectrometers require the injected ion beam to be pulsed out, but can then be used effectively. The yield of ions reaching the measurement stage here is considerably higher than those obtained from a sector field or quadrupole spectrometer which operate as a filter for a single measured mass at a time.

Storage mass spectrometers such as quadrupole ion traps or ion cyclotron resonance devices are particularly effective here. These devices are also particularly suitable for recording daughter or granddaughter ion spectra, since individual ion types can be selected and fragmented in a number of known ways.

For ions generated by matrix assisted laser desorption (MALDI), time-of-flight (TOF) mass spectrometers are particularly suitable, since the ions are already generated in short-duration pulses, as is required by these devices. More recent devices of this type, which have become known under the generic term of TOF/TOF, can also be used for the highly sensitive detection of daughter ion spectra from metastable or impact-induced ions. MALDI ions can, however, also be examined with the aid of storage mass spectrometers such as quadrupole ion trap spectrometers or ion cyclotron resonance mass spectrometers.

### SUMMARY OF THE INVENTION

The invention provides a method of electrophoresis in capillaries or other micro-structured channels for the separation of a mixture of substances, in which substances in the substance mixture are subjected to derivatization with charge-carrying chemical groups before electrophoretic separation in such a way that substances of interest for the analysis are separated from other substances by their migration rate.

It is thus the fundamental idea of the invention that through charge-generating derivatizations (that is through chemical charge management) dissociation-generated charges are given to the interesting and/or the uninteresting substances, so that the migration rate of the interesting substances at a particular pH value differs strongly from the migration rate of the uninteresting substances. By adjusting the electrophoretic separation conditions, in particular the pH value of the electrolyte, the polarity of the electrophoretic voltage and the wall coating of the capillaries, it can be arranged that the interesting substances arrive at the detector within a specified time window.

Organic biopolymers, and digestion peptides in particular, are quite predominantly electrolytically dissociated in dilute aqueous solution. For instance, tryptic digestion peptides in an acid electrolyte in dissociation equilibrium possess typically one to three positive charges. If a negative attracting voltage is applied to a suitable electrophoretic capillary column they therefore arrive at the detector earlier than neutral substances which, in the absence of additional electrophoretically generated velocity, arrive at the speed of the electroosmotic flow (EOF).

If, for example, undesired substances are given chemical groups that have at least three negative charges, then they will not be detected in the selected analytic interval before arrival of the electroosmotic flow.

Conversely, it is also possible to give desired substances negative charges and to use a column whose electroosmotic flow moves toward the detector when a positive attracting voltage is applied.

The substances of interest arriving within the time window can be passed directly to a mass spectrometer; it is also, however, possible to subject individual fractions to a further separation process, such as a chromatographic process, in a second separation dimension.

### BRIEF DESCRIPTION OF THE DRAWING

FIG. 1 shows a typical electrophorogram of a digestion peptide mixture. The digestion peptides appear after six minutes, and end after 10 minutes. After 15 minutes, some neutral substances that are flushed out with the electroosmotic flow (EOF) appear. These substances do not belong to the digestion peptides.

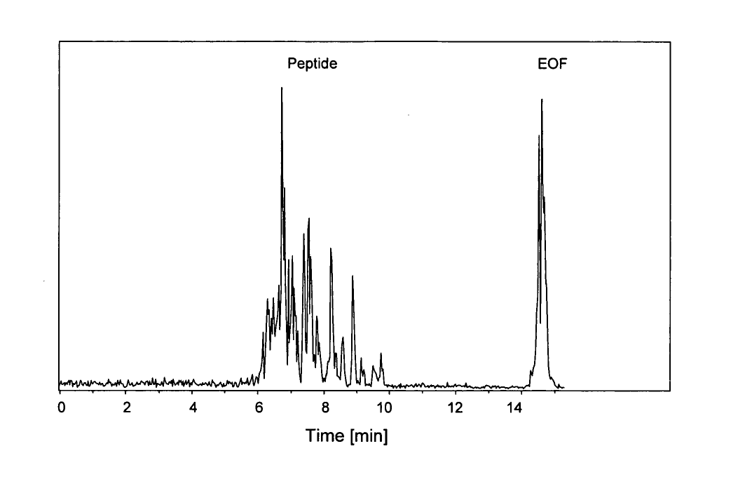

### DETAILED DESCRIPTION

The invention is directed to a method for qualitative and quantitative characterization of biological substances in complex mixtures that contain both substances of analytic interest and a large number of other substances. The invention provides a method that allows substances of particular analytic interest to be separated from the other substances, making use of an outstandingly effective separation procedure, capillary electrophoresis. A particularly favorable embodiment is related to the analysis of proteomes, where the proteins of a complex mixture are split at an early stage through enzymatic digestion and subsequent separation of the digestion peptides. The method can be used in many ways for the simplified identification of a proteome, for the determination of relative protein expressions in differently stressed proteomes, and also for the particular characterization of the proteome, possibly by post-translational modifications (PTMs) of its proteins.

The method according to the invention makes use of targeted derivatization of all the biological substances of the mixture having a common property, for instance all the digestion peptides of a proteome with an unmasked terminal amino group, with a post-translational modification (PDM), with a rare amino acid or some similar feature, and does this in such a way that the modified substances acquire a different mobility in the subsequent electrophoretic separation than that of the unmodified substances. The invention thus exploits the fact that substances of analytic interest from a complex mixture generally have one or more common properties.

Derivatization with charge groups can be carried out in one stage or in a number of stages, in which case the first stage uses known derivatization reactants for the selected functional groups, and the groups with charges that are capable of dissociation are only added at a later stage.

A few examples of derivatizations of particular functional groups, in themselves known, are given here; if necessary, the synthesis of derivates can give them further negative charges (e.g. sulfonic groups) or positive charges (e.g. pyridinium):
Acylation of terminal amino groups
Nitration of tyrosine with tetranitromethane to increase the acidity of the hydroxyl group
Conversion of histidine residues with modified pyrocarbonates
Oxidation of cysteine to cysteic acid with performic acid or peracetic acid
Alkylation of cysteine with iodoacetic acid or corresponding sulfur derivates
Modification of the cysteine with 2,2-dinitro-5,5-dithiobenzoic acid (Ellman's reagent). This leads to a fixed negative charge in the form of a carbonic acid.
Modification of the cysteine with 1-benzyl-2-chloropyridiniumbromide. A positive charge is introduced via the pyridinium ring.
Methylization of aspartate and glutamate with methanolic hydrochloric acid. This results in the removal of one negative charge for each modification introduced.
Modification of aspartate and glutamate with 2-aminoethylpiperidine or 2-amino-ethylpyrolidine in the presence of water-soluble carbodiimide. This results in the replacement of a fixed negative charge by fixed positive charge.

These, and many other possible derivatization procedures, are known to biochemists active in this field of proteome analysis.

As examples of reagents that generate charges strongly, the following are listed here:
sulfonated aromatic and aliphatic systems for negative charges, in particular trisulfonic acids for three negative charges,
quaternary ammonium compounds for positive charges,
phosphoric ester for negative charges, in particular phosphoric monoester for two negative charges.

Here too, biochemists could easily quote other dissociating groups.

Optimally, after dissociation in the pH range used for the electrophoretic buffer, the group introduced by the derivatization receives one or preferably more charges of the opposite polarity to the majority of the other substances. By adjusting the parameters for the capillary electrophoresis it is possible to ensure that almost only the selected peptides pass through the capillary column in the selected time window; the analysis is thus reduced to the desired substances. A single analysis is then sufficient to record all the peptides of one type, such as, for instance, N-terminal digestion peptides, digestion peptides with rare amino acids, or digestion peptides with post-translational modifications in a complex mixture.

If the proteins of two proteomes are given different isotopic markers, this procedure permits comparative quantification of a protein on the basis of a single digestion peptide of that protein, i.e. the detection of under or over expression of the initial protein.

A few particularly favorable embodiments are presented here:

I. The Identification and Relative Quantification of Proteins from Two Differently Stressed Proteomes by Means of the N-terminal Digestion Peptide

The aim of this type of analysis is to find those proteins that are more prevalent or less prevalent in a stressed proteome (a proteome is all the proteins of a tissue or of a bodily fluid) than in an unstressed proteome. The stress can be a physical stress such as pressure or temperature, a chemical stress, such as the administration of medication, or a biological stress resulting from aging or illness.

The proteins of a proteome are here identified by derivatization with an isotope-marked group, while those of the other proteome are treated with the same chemical group, but not isotope-marked. The isotope marking can be carried out using deuterium (²H), ¹³C, ¹⁵N, ¹⁸O or some other rare isotope, and where the use of several atoms of the isotope in the marked molecule creates a sufficiently large mass separation from the normal molecule of (as a rule) at least about six atomic mass units.

The procedure is illustrated here using the example of selection of the protein's formerly terminal digestion peptides:

1. The free primary amino groups of the intact proteins (in particular, the amino groups of the relevant N-terminal) in the two, still separate, proteomes are identified using an isotope-marked group, for example using ¹³C atoms for the “isotope-marked” protein, and ¹²C atoms for the other, unmarked but otherwise identically derivatized proteome. This marking is at the same time also a masking that protects against further derivatization of the amino groups.

2. The two proteomes are mixed, and digested together with trypsin.

3. All the primary amino groups that have been released by the enzymatic digestion are now derivatized with a functional group having three negative charges each, for example with a trisulfonic acid. The derivatization affects all the digestion peptides that were not previously N-terminal, that is all the digestion peptides whose amino groups were not masked. They are excluded from the analysis by the negative charges, since they do not arrive at the end of the capillary or channel in front of the electroosmotic flow.

4. The solution containing the thousands of digestion peptides is now inserted into the capillary or channel for subsequent electrophoresis by electrodynamic or hydrostatic injection and with the aid of an acid buffer system.

5. The peptides are separated by the application of an electric field, the negative potential being connected to the detector end: only those digestion peptides that were previously N-terminal from each of the proteins reach the detector.

A mass spectrometer is used as the detector; from the relative intensities of the two isotope groups of a digestion peptide it is possible to obtain a relative quantification, and this provides information about the relative expressions of the associated protein in the stressed proteome. Identification can be made either by determining the partial amino acid sequences using tandem mass spectrometry followed by a search in a protein sequence databases, or by a measurement of the migration rate in combination with a determination of the precise mass. An analogous procedure can be used non-differentially to achieve easy, fast identification of numerous proteins in a proteome. Similarly, the procedure can also be applied to the derivatization of the C-terminal peptide.

II. The Identification and Quantification of Proteins Using Rare Amino Acids

The N-terminal digestion peptides are not employed here for the analysis, but digestion peptides with relatively rare amino acids are exploited instead. This involves all the amino acids with specific functional groups being derivatized with negative charges. An analysis of the mixture in an electrolyte that is not too acid by means of electrophoretic separation, with the positive potential connected to the detector end, has the effect that only the modified digestion peptides (also negatively charged in the acid pH range) reach the detector in the relevant time window.

III. The Determination of Post-Translational Modifications

Fundamentally, two techniques are available here, depending on the application:

A. The peptide is modified in such a way at the modification (for example, the phosphor groups of phosphorylated amino acids, or the sugar residue of glycosylated locations) that, at a specific pH value of the buffer, it acquires a charge opposite to that of the other peptide.

B. All amino acids that are suitable for the modification, but which do not carry a modifying group, are derivatized at this point in such a way that they are not detected.

Here are a few examples:
In order to determine phosphorylations, phosphor residues can be alkylized with amines using carbodiimides (e.g. EDC, 1-ethyl-3-(3-dimethylaminopropyl)carbodiimide hydrochloride). Negative charge carriers can be introduced in this way.
By eliminating the phosphate group, negative charges can again be introduced by addition to the double bond created.
In order to determine glycolizations, the hydroxy groups of the sugar can be oxidized to aldehyde with sodium periodate; various derivatizations can then be carried out on these groups, perhaps through the formation of a hydrazine derivate.

Other modifications can be selectively analyzed by the same procedure through the appropriate selection of reagents. Appropriate derivatization techniques are again known to the biochemist.

All the procedures described can also be performed in an analogous manner by the introduction of positive derivatizations and electrophoretic separation under basic conditions and with a field of the opposite polarity. Quantification relating to the percentage rates of the modification can also be carried out in these investigations of post-translational modifications. Isotope marking can again be used successfully here. Capillary electrophoresis can be carried out both in aqueous and in organic solvents (non aqueous capillary electrophoresis—NACE). Because a lower degree of peptide ionization is to be expected in organic solvents, the introduction of permanent charges holds out a particular promise of success. The method according to the invention can, in principle, also be used for other molecules in complex mixtures. In comparison with LC methods, capillary electrophoresis can be more easily miniaturized. This permits a saving in time; it is also possible to achieve parallelization through processes operating simultaneously. The invention is therefore also particularly promising for microstructured analysis systems. The method according to the invention can also be combined with other separation procedures for multi-dimensional separations, for example to form a CE-HPLC procedure.

1. A method of capillary electrophoresis for the separation and analysis of substance mixtures in an electrolyte, wherein only a portion of the substances in the mixture of substances is of interest for analysis, the method comprising subjecting the substances in the substance mixture to derivatization using chemical groups that create electric charges before the substances undergo electrophoretic separation, so that the substances of analytic interest can be separated from a majority of the other substances by means of their migration rate in the electrolyte.

2. A method according to claim 1, wherein the substances of analytic interest in the mixture have one or more functional groups that can be derivatized, and wherein the majority of those substances that are not of interest for the analysis do not possess these functional groups.

3. A method according to claim 1, wherein the substances that are not of interest to the analysis have one or more functional groups that can be derivatized, and wherein the substances that are of interest for the analysis do not possess these functional groups.

4. A method according to claim 1, wherein the substances are detected by mass spectrometry.

5. A method according to claim 4, wherein the mixture of substances comprises digestion peptides from whole or partial proteomes.

6. A method according to claim 5, wherein the derivatization is carried out in at least two steps, one before the digestion and one afterwards.

7. A method according to claim 5 for the determination of the relative concentrations of proteins in two different proteomes, wherein the proteins of the two proteomes are identified by different isotopic markers through derivatization prior to mixing the two proteomes.

8. A method according to claim 5, wherein the relative concentrations of proteins with and without post-translational modifications are determined.

9. A method according to claim 1, wherein the electrophoretic separation is followed by a further separating step in a second dimension.
